(19) United States
(12) Patent Application Publication
(10) Pub. No.: US 2012/0164969 A1
(43) Pub. Date: Jun. 28, 2012

(54) SYSTEM AND METHOD OF LOCATION DETERMINATION OF A MOBILE DEVICE

(75) Inventors: Ashok Bhatia, San Diego, CA (US); Kirk Allan Burroughs, Alamo, CA (US)

(73) Assignee: QUALCOMM INCORPORATED, San Diego, CA (US)

(21) Appl. No.: 13/244,473

(22) Filed: Sep. 24, 2011

Related U.S. Application Data
(60) Provisional application No. 61/426,435, filed on Dec. 22, 2010.

(51) Int. Cl. H04W 4/00; H04W 4/22

(52) U.S. Cl. 455/404.2; 455/456.1

(57) ABSTRACT

A method includes receiving a command corresponding to a user input at a user interface of a mobile device. The method includes comparing the received command to a predetermined set of commands associated with determining a location of the mobile device. The method further includes initiating a wireless data signal scan (e.g., prior to receiving an explicit request from Base Station or PDE) to generate a list that identifies wireless data (e.g., non-global positioning system (non-GPS)) signals that are detectable by the mobile device in response to determining that the received command corresponds to at least one command of the predetermined set of commands.

### CROSS-REFERENCE TO RELATED APPLICATIONS

This application claims the benefit of U.S. Provisional Patent Application No. 61/426,435 filed on Dec. 22, 2010 and entitled “METHOD TO IMPROVE TIME-TO-FIX FOR POSITION LOCATION IN HYBRID ASSISTED E911,” the contents of which are expressly incorporated herein by reference in its entirety.

### BACKGROUND

I. Field of the Invention

The present disclosure is generally related to location determination of a mobile device.

II. Background

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

One of such computing capability is the ability to perform location determination. Portable electronic devices such as mobile phones (alternately referred to as “mobile stations”) may be equipped with global positioning system (GPS) transceivers that enable the electronic device to determine its location and implement location-based services. Emergency call flows, such as the Federal Communications Commission (FCC) mandated Enhanced 911 (E911) service, involve a mobile phone determining and providing its location to a public safety answering point (PSAP). The PSAP then forwards the location to emergency services (e.g., police, ambulatory services, fire, rescue, etc). Various performance standards and carrier specifications (e.g., J-STD-036 and IS-801-1) established in response to the FCC mandate specify timing considerations for a mobile station responding to position related requests from a position determining entity (PDE). Typical values of these times (e.g., the time from when an E911 call is initiated to the time when the location information is forwarded may be about 15-16 seconds. A PDE or a mobile station may determine the position or geographical location of a mobile station while the mobile station is engaged in the emergency call.

### BRIEF SUMMARY

With advances in technology, it may be possible for a mobile station to detect the presence of various non-GPS signals of opportunity (e.g., non-GPS signals that may be used to determine a location of the mobile station). Examples of such signals include, but are not limited to, Wi-Fi measurements, long term evolution (LTE) signals, signals from television (TV) towers, QR codes, and near field communications (NFC) signals with position beacons that may be used to determine a prefix position of the mobile station. In some of these scenarios, the position obtained by such signals may not be very accurate. Generally, such a coarse prefix position may subsequently be used by a GPS receiver to generate a more precise position estimate (e.g., a GPS “fix”) of a mobile device. Providing a prefix position to a GPS module at the mobile station may reduce a time taken to determine the more precise GPS fix. For example, the GPS module may use the prefix to narrow down a list of satellite positioning system (SPS) or global navigation satellite system (GNSS) satellites and/or time/frequency hypotheses used to acquire the satellites.

However, due to the timing constraints involved in E911 standards (e.g., IS-801 call flow), a mobile station may not be able to measure available signals of opportunity, provide the measurements to a PDE, receive prefix information from the PDE, use the prefix information to determine a GPS fix, and provide the GPS fix to the PDE within the allotted time. For example, scanning all wireless local area network (WLAN) 802.11 channels and detecting all access points near a mobile station may take 3 or more seconds. Measuring other non-GPS signals of opportunity may further add to the measurement duration.

A system and method of location determination of a mobile device that uses non-GPS signals of opportunity is disclosed. The system and method may enable (e.g., during hybrid assisted E911) a mobile device to use non-GPS signals (e.g., 802.11 (Wi-Fi) signals, LTE signals, TV signals, QR codes, NFC signals, code division multiple access (CDMA) signals, or other signals) to improve a time-to-fix of the mobile device. For example, instead of beginning the process of obtaining a GPS fix after the E911 call has been initiated (e.g., in accordance with the IS-801 standard), the mobile device may instead measure non-GPS signals of opportunity before the E911 call flow even begins. For example, the mobile device may send non-GPS signal measurements to a PDE before the PDE requests the GPS fix (i.e., at an earlier time/stage of the E911 call flow), and the PDE may use the non-GPS signal measurements to calculate a prefix of the mobile device.

Starting the measurements of non-GPS signals of opportunity before the emergency call is originated may provide extra time (e.g., 4-5 seconds) to collect the measurements. As a result, by the time the first message related to the positioning call flow arrives at the mobile station, non-GPS measurements may be available and may be sent to the PDE for prefix calculation. Thus, non-GPS signals may be made available for prefix calculation more quickly. Accordingly, a mobile phone operating in accordance with the present disclosure may begin scanning Wi-Fi signals (or other non-GPS signals) before the E911 call flow begins. For example, the mobile phone may begin scanning Wi-Fi signals as soon as an indication of an emergency call is received (e.g., as soon as the sequence ‘9,’ ‘1,’ ‘1’ is received at a keypad, a touchscreen, or any other user interface of the mobile phone). It should be noted that the disclosed techniques may also be used in applications other than emergency call applications. For example, signal scans may generally be started in response to detecting a command at the mobile station that is predicted to lead to a subsequent location determination. To illustrate, such commands may include activation of a camera when the mobile device detects that the user frequently geo-tags photographs taken by the camera, activation of a navigation or maps application that has GPS capability, and activation of a social networking application when the mobile device detects that the user frequently “checks-in” to report their location.

In a particular embodiment, a method includes receiving a command corresponding to a user input at a user interface of a mobile device. The method includes comparing the received command to a predetermined set of commands associated with determining a location of the mobile device. The method further includes, in response to determining that the received command corresponds to at least one command of the predetermined set of commands, initiating a wireless data signal scan to generate a list that identifies wireless data signals (i.e., non-GPS signals) that are detectable by the mobile device.

In another particular embodiment, an apparatus includes a processor configured to receive a command corresponding to a user input at a user interface of a mobile device. The processor is further configured to compare the received command to a predetermined command associated with determining a location of the mobile device. In response to determining that the received command corresponds to the predetermined command, the processor is configured to initiate a wireless data signal scan to generate a list that identifies wireless data signals that are detectable by the mobile device.

In another particular embodiment, a mobile device includes a user interface configured to receive a user command. The mobile device includes a first receiver configured to receive global positioning system (GPS) signals and a second receiver configured to receive non-GPS signals. The mobile device further includes a processor coupled to a memory, where the memory is configured to store a plurality of predetermined commands associated with determining a location of the mobile device. The processor is configured to compare the user command received via the user interface to a plurality of predetermined commands. In response to the user command corresponding to at least one of the plurality of predetermined commands, the processor is further configured to initiate a wireless data scan at the second receiver to generate a list of wireless data signals that are detectable by the second receiver.

In another particular embodiment, a method includes receiving, at a position determining entity (PDE), a list from a mobile device. The list identifies wireless data signals that are detectable by the mobile device. The list is received independent of transmitting a request for location information from the PDE to the mobile device. For example, the list may be received before transmitting the request. The method also includes determining location information associated with the mobile device based on the list and transmitting the location information to the mobile device. The method further includes receiving global positioning system (GPS) position information from the mobile device. The GPS position information is based at least in part on the location information transmitted from the PDE to the mobile device.

A particular advantage provided by at least one of the disclosed embodiments is an improved time-to-fix of a mobile device by using various signals of opportunity (i.e., non-GPS signals) that are detectable by the mobile device and making the non-GPS signals available for location determination earlier in the call flow. Another particular advantage is faster and more accurate emergency response due to the ability of the mobile device, a PDE, a base station, or a PSAP to quickly and accurately determine a location of a mobile device. Thus, an overall improvement of an E911 system may be achieved.

Other aspects, advantages, and features of the present disclosure will become apparent after review of the entire application, including the following sections: Brief Description of the Drawings, Detailed Description, and the Claims.

### BRIEF DESCRIPTION OF THE DRAWING

FIG. 1 is a diagram that illustrates a particular embodiment of a communication system that is operable to determine the location of a mobile device.

FIG. 2 illustrates another particular embodiment of a communication system that is operable to determine the location of a mobile device.

FIG. 3 is a diagram that illustrates a call flow between a mobile station and a position determining entity (PDE) during an E911 call at the communication systems of FIG. 1 or FIG. 2.

FIG. 4 is a flow chart of a particular illustrative embodiment of a method of location determination of a mobile device.

FIG. 5 is a flow chart of another particular illustrative embodiment of a method of location determination of a mobile device.

FIG. 6 is a block diagram of a particular embodiment of a wireless device including a processor that is operable to perform location determination.

### DETAILED DESCRIPTION

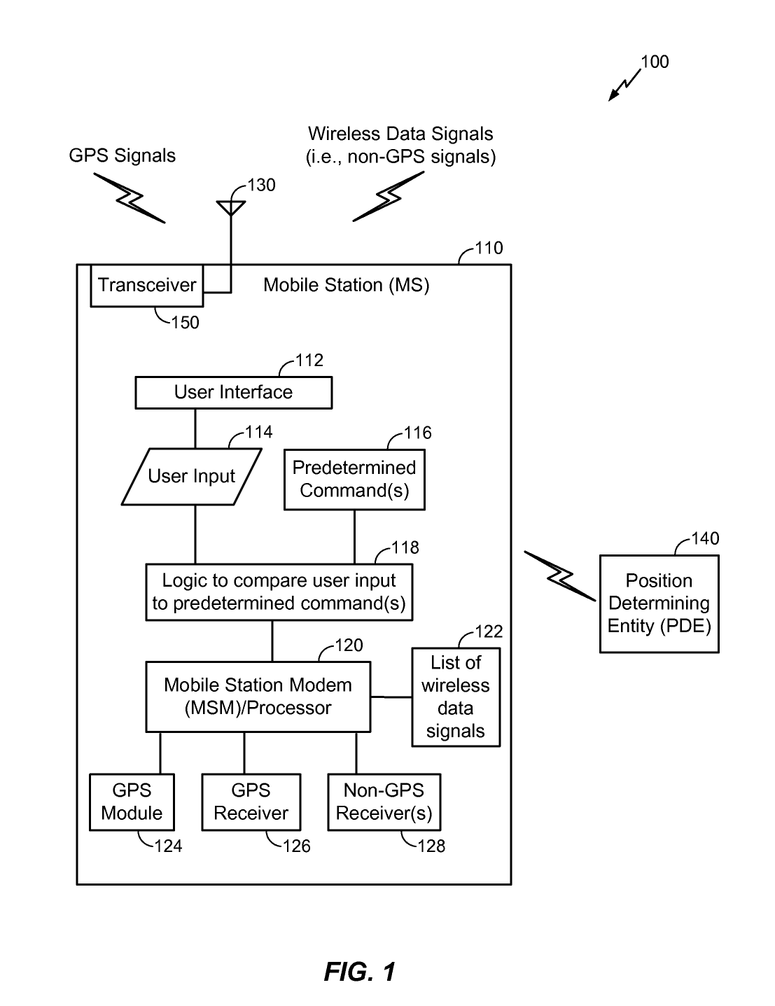

Referring to FIG. 1, a particular embodiment of a communication system to determine the location of a mobile device is disclosed and generally designated 100. The communication system 100 includes a mobile station 110 that is operable to communicate with a position determining entity (PDE) 140. The PDE 140 may be a mobile-assisted PDE, a network-based PDE, or a hybrid PDE. The mobile station 110 includes an antenna 130 coupled to a transceiver 150. The mobile station 110 may receive global positioning system (GPS) signals and wireless data signals (i.e., non-GPS signals), as illustrated. The mobile station 110 includes a user interface 112, logic 118 to compare an input to predetermined commands, and a processor 120 (which may include an integrated mobile station modem (MSM)). The logic 118 may be implemented as a processor or another type of computing device. The logic 118 may be implemented using software instructions executed by a processor (e.g., the processor 120). The mobile station 110 further includes a GPS module 124, a GPS receiver 126, and a non-GPS receiver 128. An example of a non-GPS receiver 128 is a wireless local area network (WLAN) receiver that is configured to receive wireless data signals, such as Wi-Fi signals. Other types of non-GPS wireless data signals may also be received, as described herein.

The processor 120 is coupled to the logic 118 and may generate a list 122 of wireless data signals. The logic 118 is responsive to the user interface 112 to receive a representative user input 114. The user interface 112 may be a keypad, a touchscreen, or any other type of user interface for receiving a user input at a mobile device. The mobile station 110 further includes a memory (not shown) that is configured to store the plurality of predetermined commands 116, where each predetermined command is associated with determining a location of the mobile station 110. For example, the predetermined command may be an input sequence of ‘9,’ ‘1,’ ‘1,’ may activate an emergency application or other application at the mobile station 110, or another command that is predicted to lead to a subsequent location determination. The memory may be stored within any of the processors of the mobile station 110 or may be a separate memory within the mobile station 110 that is coupled to one or more of the processors. For example, the processor 120 may be coupled to the memory that stores the predetermined commands 116.

The processor 120 is configured to perform a variety of functions including comparing a user command (e.g., the user input 114) received via the user interface 112 to the plurality of predetermined commands 116. In response to the user input 114 corresponding to (e.g., matching) at least one of the predetermined commands 116, the processor 120 may initiate a wireless data signal scan at the non-GPS receiver 128 to generate the list 122 of wireless data signals. The list 122 of wireless data signals may represent a list of signals and frequencies that are detectable by the non-GPS receiver 128. For example, when the wireless data signals include Wi-Fi signals, the list 122 may identify Wi-Fi access points (and corresponding signal strengths) within range of the mobile station 110. When the wireless data signals include other types of non-GPS signals, the list 122 may include identities and locations of access points or signal sources, signal strengths, signal frequencies, and other information. In a particular embodiment, the wireless data signal scan is initiated before receiving a location request from a base station (not shown in FIG. 1) of a wireless network or from the position determining entity (PDE) 140 and before initiating a GPS scan or GPS session at the mobile station 110.

Thus, a measurement of non-GPS signals may begin prior to or independently from the start of a positioning call flow with the PDE 140. Instead, one or more predetermined emergency numbers or commands stored at the mobile station 110 may be used to detect the origination of an emergency call or other event related to location determination at the mobile station 110. In response to detecting that an emergency call attempt is being made (or that an event related to location determination has occurred), the mobile device may begin measurements for detectable non-GPS signals. For example, the wireless data signal scan may be initiated by the processor 120, and the list of wireless data signals 122 may be generated before the mobile station 110 receives a location request from the PDE 140 or from a base station within range of the mobile station 110.

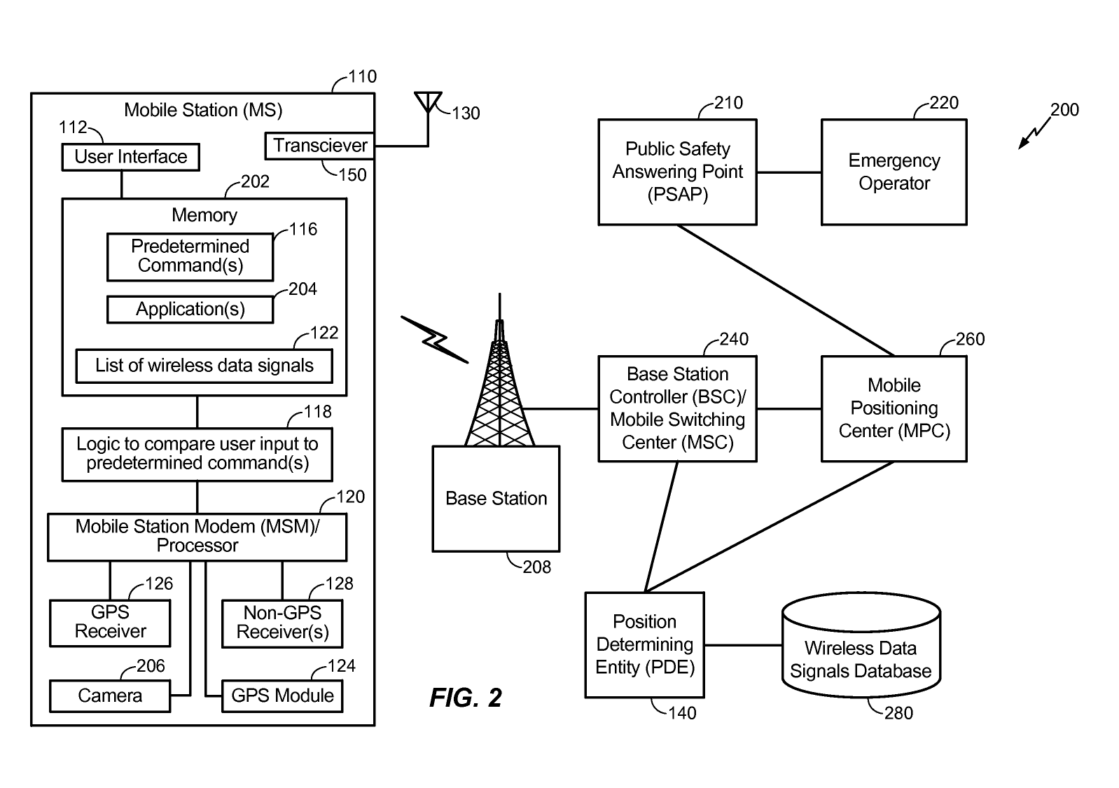

In a particular illustrative embodiment, the transceiver 150 of the mobile station 110 may include a transmitter component configured to transmit the list 122 of wireless data signals to a base station (not shown in FIG. 1) or to the PDE 40. The PDE 140 may be collocated with a base station such as a wireless base station that supports cellular communication. Alternatively, the PDE 140 may be a separate component that is in communication with the base station but is not collocated with the base station. For example, the PDE 140 may be implemented by a processor within a computer server that is part of a network coupled to the base station. The PDE 140 may include logic to process the list 122 of wireless data signals to determine a calculated prefix location of the mobile station 110. The PDE 140 may also include logic for trilateration or triangulation of signals received from multiple mobile stations. In a particular embodiment, the PDE 140 may include or have access to a database (not shown) that associates Wi-Fi access point media access control (MAC) addresses with location information. Thus, when the list 122 of wireless data signals from the mobile station 110 includes MAC addresses for Wi-Fi access points within range of the mobile station, the PDE may use the list to search the database for prefix information. Use of MAC addresses to determine prefix information is further described with reference to FIG. 2.

During operation, a user may provide a user command to the mobile station 110 via the user interface 112. Receiving a user command is represented by the user input 114 provided to the logic 118. The logic 118 may compare the received command (e.g., the user input 114) to a predetermined command, such as one or more of the predetermined commands 116 associated with determining a location of the mobile station 110. In response to determining that the received command (e.g., the user input 114) corresponds to one of the predetermined commands 116, the logic 118 may initiate a wireless data signal scan at the non-GPS receiver 128 to generate the list 122 of wireless data signals. As further described with reference to FIGS. 2-6, the list 122 of wireless data signals detected by the mobile station 110 may be transmitted to the PDE 140 after initiation of an E911 call, may be used to determine prefix information for the mobile station 110, and may be used to accelerate GPS fix determination by the GPS receiver 126 at the mobile station 110.

In a particular illustrative embodiment, the wireless data signal scan is initiated before receiving a location request from a base station of a wireless network or from the PDE 140. The list 122 of wireless data signals may thus be determined before such information is requested by a base station or from the PDE 140. For example, the list 122 may be generated before the PDE 140 requests a GPS fix from the mobile station 110 during an E911 call flow. Since location determination may be performed at the mobile station 110 and at the PDE 140, the PDE 140 may be referred to as a hybrid PDE.

As explained above, it should be understood that the wireless data signals within the list of wireless data signals 122 do not include GPS signals. Rather, the wireless data signals are non-GPS signals, such as local wireless local area network (WLAN) signals such as defined by the IEEE specifications 802.11x or 802.15x, wireless wide area network (WWAN) signals, wireless personal area network (WPAN) signals, third generation partnership project (3GPP) signals, third generation partnership project 2 (3GPP2) signals, global system for mobile communications (GSM) signals, code division multiple access (CDMA) signals, time division multiple access (TDMA) signals, frequency division multiple access (FDMA) signals, orthogonal frequency division multiple access (OFDMA) signals, single-carrier frequency division multiple access (SC-FDMA) signals, long term evolution (LTE) signals, worldwide interoperability for microwave access (WiMAX) signals, television (TV) signals, quick response (QR) codes, near field communications (NFC) signals, digital advanced mobile phone system (D-AMPS) signals, or any combination thereof.

In a particular embodiment, at least one of the predetermined commands 116 is a command to initiate a call to an emergency phone number (e.g., “911” in the United States). One of the predetermined commands 116 may include a command to launch an application at the mobile station 110 (e.g., a camera application, a navigation application, a social networking application, etc), where the mobile station 110 has detected or otherwise determined that the application frequently performs location determination or requests GPS information from the GPS module 124 and the GPS receiver 126. To illustrate, a user may frequently geo-tag photographs taken using the camera application, frequently activate a GPS capability of the navigation application, and frequently “check in” to report their location using the social networking application.

The system 100 of FIG. 1 may enable the PDE 140 to quickly and accurately determine and/or receive location information in response to an emergency request from a mobile station 110. For example, the PDE 140 may receive the list 122 of wireless data signals and may perform or be ready to perform prefix determination. Based on the prefix determination, the PDE 140 may generate general location information that may be used by the mobile station 110 to later quickly obtain a GPS fix of the mobile station 110. Thus, upon receipt of an emergency request from the mobile station 110, the PDE 140 and the mobile station 110 may provide location information more quickly in response to the emergency request. In addition, the system 100 of FIG. 1 may enable earlier and/or faster GPS fix determination when a user executes non-emergency applications, thereby providing an improved user experience. Moreover, when the mobile station 110 is located indoors or somewhere that makes it difficult to communicate with GPS satellites, the system 100 of FIG. 1 may enable at least a coarse position determination (by use of prefix information) for the mobile station 110 based on non-GPS (e.g., Wi-Fi) signals.

Referring to FIG. 2, another particular embodiment of a communication system that is operable to determine the location of a mobile device is disclosed and generally designated 200. The communication system 200 includes further details regarding the mobile station 110 of FIG. 1 and includes other components such as network components that may be in communication with the mobile station 110.

The mobile station 110 includes various components as illustrated in FIG. 1 and includes further components for illustrative purposes. For example, the mobile station 110 may include an illustrated memory 202 that stores the predetermined commands 116 and the list 122 of wireless data signals. The memory 202 may also store applications 204 that are executable by one or more processors within the mobile station 110. For example, the applications 204 may include mobile applications such as user interface applications, video or image processing applications, communication applications, and social networking applications that may be executed at the mobile station 110. To illustrate, the processor 120 may execute a camera application that processes information received from a camera 206.

The mobile station 110 may communicate via an antenna 130 with a base station 208. The antenna 130 is coupled to the transceiver 150 that includes a transmitter component and a receiver component. The mobile station 110 may include a plurality of transmitters, receivers, and/or transceivers. The base station 208 is coupled to a base station controller (BSC)/mobile switching center (MSC) 240. The base station 208 may support radio communications with one or more mobile stations. The BSC/MSC 240 may be coupled to the PDE 140 and to a mobile positioning center (MPC) 260. The MPC 260 may serve as a point of interface to a wireless network for location determination. For example, the MPC 260 may retrieve, forward, store, and control position data within the wireless network. The MPC 260 may select the PDE 140 from a plurality of PDEs for use in position determination, and the MPC 260 may forward position information to a requesting entity (e.g., a PSAP 210 directed by an emergency operator 220 (e.g., 911 dispatch operator)) or store the position information for subsequent retrieval. Typically, the emergency operator 220 may access the PSAP 210 via a dedicated workstation or other terminals that are directly coupled thereto. For example, the PSAP 210 may be an operation center that is staffed by emergency personnel or other safety personnel to respond to emergency calls. Alternately, the emergency operator 220 accessing the PSAP 210 may forward an emergency request to an appropriate service provider (e.g., fire, rescue, police, ambulance, etc).

The PDE 140 may be coupled to or otherwise have access to a database 280 of wireless data signals and associated location information (e.g., location information stored at a server). The PDE 140 may receive the list 122 of wireless data signals from the mobile station 110 and may use the list 122 to determine location information (e.g., a prefix) for the mobile station 110 via the database 280. The PDE 140 may provide the prefix to the mobile station 110. In a particular embodiment, when the PDE subsequently receives or determines a GPS fix of the mobile station 110, the PDE may forward the GPS fix to the MPC 260, which may relay the GPS fix to the PSAP 210 for emergency personnel use.

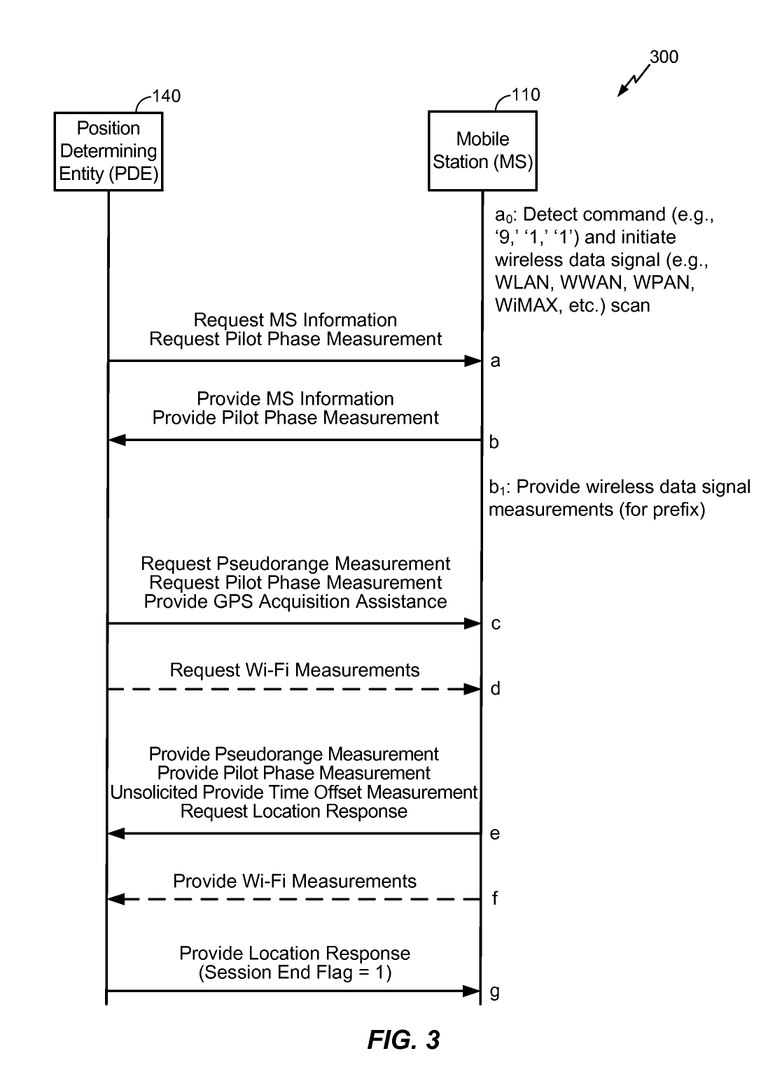

During operation, the mobile station 110 may receive user input that corresponds to a predetermined command 116. For example, the mobile station 110 may receive the input sequence ‘9,’ ‘1,’ ‘1’ (or perhaps just the input sequence ‘9’ or just the input sequence ‘9,’ ‘1’) via the user interface 112. In response, the non-GPS receiver 128 may initiate a wireless data signal scan of one or more types of non-GPS signals, such as CDMA signals, LTE signals, Wi-Fi signals, TV signals, etc. To illustrate, a Wi-Fi signal scan may generate the list 122 (including MAC addresses of Wi-Fi access points within range of the mobile station 110). Subsequently to the detection of the input sequence (e.g., ‘9,’ ‘1,’ ‘1’), an E911 call flow may be initiated, as further described with reference to FIG. 3.

The mobile station 110 may transmit the list 122 to the base station 208 and/or the PDE 140. The PDE 140 may use the list 122 to determine location information for each of the Wi-Fi access points via the database 280. The PDE 140 may use such location information to determine a prefix for the mobile station 110 (e.g., via triangulation using multiple access point locations or via some other method). The PDE 140 may transmit the prefix to the mobile station 110.

As an alternative option, the prefix may also be provided to the PSAP 210. In response to receiving the prefix information, the PSAP 210 may activate emergency response services. For example, the emergency operator 220 may begin dispatching a police, fire, or ambulance vehicle with the understanding that a more precise GPS fix may subsequently be provided to the dispatched (e.g., en route) emergency vehicle. In response to receiving the prefix information, the mobile station 110 may use the prefix information to more quickly determine a GPS fix via the GPS receiver 126. When the GPS fix is determined, the GPS fix may be relayed by the mobile station 110 to the base station 208, which forwards the GPS fix to the PSAP 210 in accordance with an E911 call flow.

Thus, the system 200 of FIG. 2 may enable determination of location information at least partially based on the wireless data signals detected by the mobile station 110 and prior to or during early stages of an E911 call flow, resulting in earlier and/or faster location determination and an improved emergency response time.

Referring to FIG. 3, a particular embodiment of an E911 call flow between a mobile station 110 and a PDE 140 is shown and generally designated 300. For example the call flow 300 depicted in FIG. 3 may represent modifications to an IS-801 E911 call flow according to the present disclosure.

At point a₀, the mobile station 110 may detect a command from a user (e.g. ‘9,’ ‘1,’ ‘1’) and, in response to the user command, the mobile station 110 may initiate a wireless data signal scan of wireless data signals (e.g., WLAN, WWAN, WPAN, WiMAX, etc.) that are detectable by the mobile station 110. The wireless data signal scan may be initiated before a request for location information is received by the mobile station 110 from the PDE 140. Thus, the list of wireless data signals 122 may be generated and available at the mobile station 110.

Subsequent to the initiation of the wireless data signal scan, the PDE 140 may send a request for location information to the mobile station 110, at point a. For example, the request for location information may include a request for mobile station information and a request for pilot phase measurement, as illustrated.

At point b, the mobile station 110 may provide the requested information to the PDE 140. In accordance with the present disclosure, at point b₁ (which may be substantially concurrent to point b), the mobile station 110 may also provide wireless data signal measurements to the PDE 140. For example, the mobile station may provide information and measurements of non-GPS signals (e.g., Wi-Fi, WLAN, WPAN, TV, LTE, etc.) that are detectable by the mobile station 110. To illustrate, information regarding Wi-Fi signals may be represented by a list of Wi-Fi access points, such as the list 122 of FIGS. 1-2. Information regarding other types of non-GPS signals may include identities and locations of access points or signal sources, signal strengths, signal frequencies, and other information. The wireless data signal measurements may be used for prefix calculations/determinations at the PDE 140. It should be noted that points a₀ and b₁ are not performed in the IS-801 E911 call flow and are performed in accordance with the present disclosure. Accordingly, wireless data signal measurements may be provided to the PDE 140 at an earlier point during the E911 call flow to achieve earlier and/or faster location determination of the mobile station 110.

At point c, the PDE 140 sends a request for pseudorange measurement and pilot phase measurement to the mobile station 110 and also provides GPS acquisition assistance to the mobile station 110. According to the IS-801 standard, a request for Wi-Fi measurements may be transmitted from the PDE 140 to the mobile station 110 at point d. However, because the mobile station 110 has already provided the wireless data signal measurements to the PDE 140 at point b₁, this step may not need to be performed in the present disclosure.

At point e, the mobile station 110 may provide pseudorange measurements, pilot phase measurements, and unsolicited time offset measurements to the PDE 140, and the mobile station 110 may request a location response from the PDE 140, as illustrated. At point f, the mobile station 110 may provide the requested Wi-Fi measurements to the PDE 140. However, as described above, according to the present disclosure, this information is provided to the PDE 140 at an earlier time during the call flow (i.e., at point b₁), and thus this step may not be performed.

At point g, the PDE 140 may provide a location response (e.g., a prefix based on the list 122 of wireless data signals, as disclosed herein) to the mobile station 110. Thus, a scan of wireless data signals may be initiated by the mobile station 110 earlier and may be provided to the PDE 140 at an earlier stage in the call flow 300. Thus, a reduced response time may be achieved using the call flow 300 of FIG. 3.

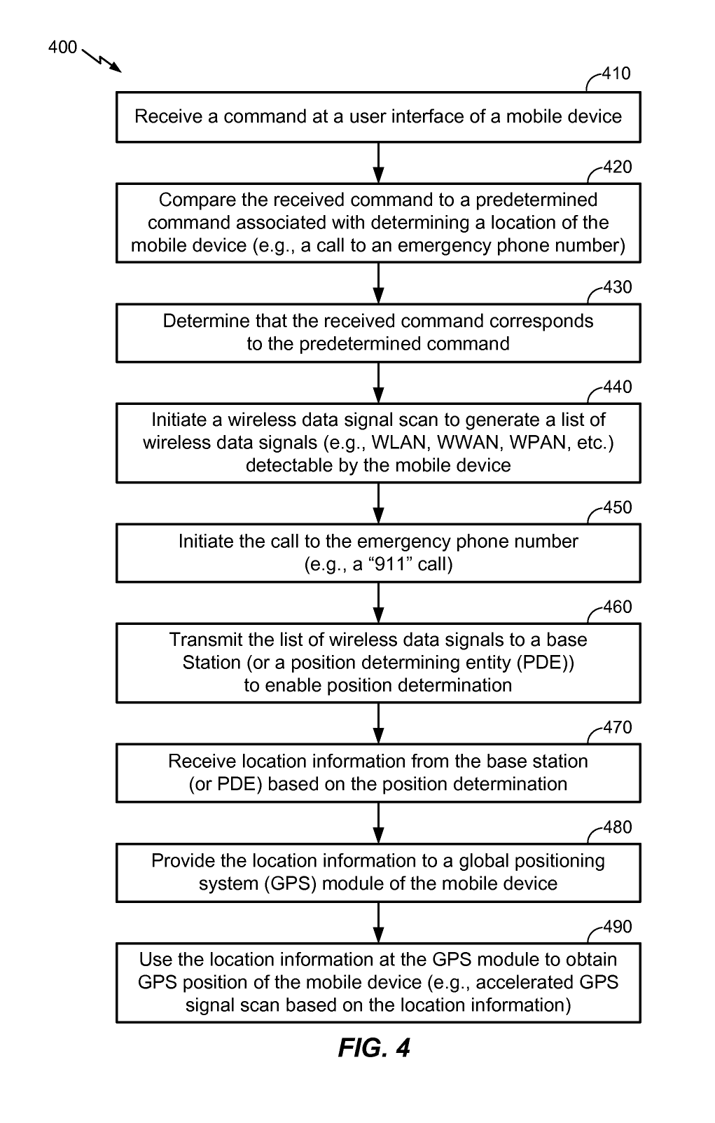

Referring to FIG. 4, a particular illustrative embodiment of a method of location processing of a mobile device is shown, and designated as 400. In an illustrative embodiment, the method 400 may be performed at the mobile station 110 of the system 100 of FIG. 1 or the system 200 of FIG. 2.

The method 400 includes receiving a command at a user interface of a mobile device, at 410. For example, in FIG. 1, the user input 114 may be received at the logic 118 of the mobile station 110. The method 400 further includes comparing the received command to a predetermined command associated with determining a location of the mobile device (e.g., a call to an emergency phone number), at 420. For example, in FIG. 1, the user input 114 may be compared to the predetermined commands 116 by the logic 118.

The method 400 further includes determining that the received command corresponds to the predetermined command, at 430, and initiating a wireless data signal scan to generate a list of wireless data signals (e.g., WLAN, WWAN, WPAN, etc.) detectable by the mobile device, at 440. For example, in FIG. 1, the processor 120 may determine that the user input 114 corresponds to the predetermined command 116, and the non-GPS receiver 128 (or multiple receivers) may perform the wireless data signal scan.

The method 400 includes initiating the call to the emergency phone number (e.g., a “911” call), at 450. The list of wireless data signals is transmitted to a base station or a position determining entity (PDE) to enable position determining information, at 460. Step 460 may be performed before, during or after stop 450. For example, in FIGS. 1-2, the list 122 of wireless data signals may be sent to the PDE 140 and/or the base station 208.

The method 400 also includes receiving location information from the base station 208 (or PDE 140) based on the position determination, at 470, and providing the location information to a global positioning system (GPS) module at the mobile device, at 480. For example, with reference to FIGS. 1-2, the location information (e.g., prefix information) received from the base station 208 or from the PDE 140 may be provided to the GPS module 124 of the mobile station 110.

The method 400 further includes using the location information at the GPS module to obtain a GPS position of the mobile device, at 490. For example, in FIG. 1, the prefix information may be used at the GPS module 124 to obtain a GPS fix of the mobile station 110. To illustrate, the GPS operations at the GPS module 124 and at the GPS receiver 126 may be accelerated by the presence of the prefix information.

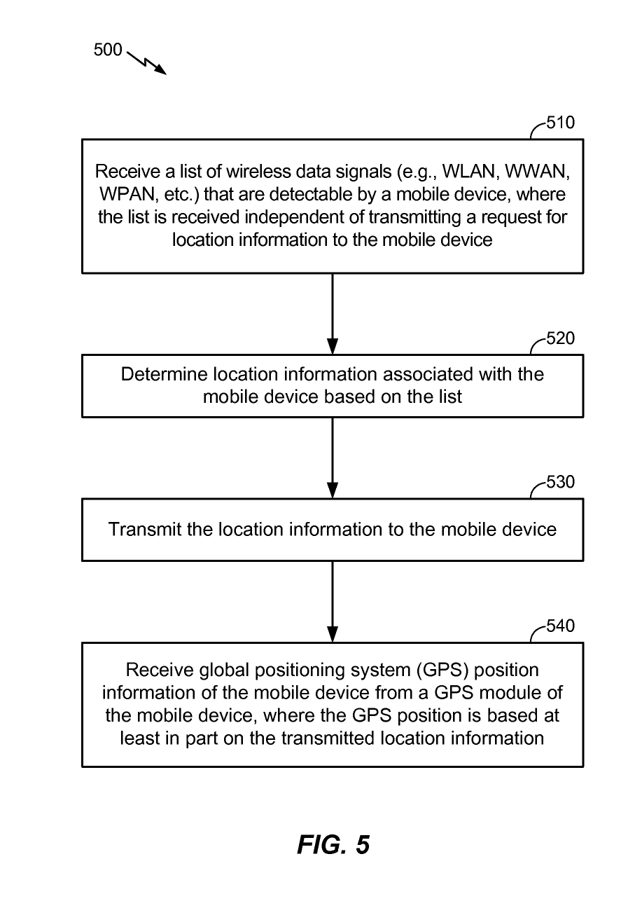

Referring to FIG. 5, another particular illustrative embodiment of a method of determining a location of a mobile device is shown, and designated as 500. In an illustrative embodiment, the method 500 may be performed at the system 100 of FIG. 1 or at the system 200 of FIG. 2.

The method 500 includes receiving a list of wireless data signals (e.g., WLAN, WWAN, WPAN, etc.) that are detectable by a mobile device, at 510. The list is received independent of transmitting a request for location information to the mobile device. For example, with reference to FIGS. 1-2, the list 122 of wireless data signals may be received at the base station 208 or the PDE 140. The list 122 may be generated by the mobile station 110 before the PDE 140 sends a request to the mobile station 110 for location information. The method 500 further includes determining location information associated with the mobile device based on the list, at 520. For example, with reference to FIGS. 1-2, the PDE 140 may use the list 122 to calculate an approximate (e.g., prefix) location of the mobile station 110 by accessing and processing information received from the wireless data signals database 280.

The method 500 also includes transmitting the location information to the mobile device, at 530, and includes receiving global positioning system (GPS) position information of the mobile device from a GPS module of the mobile device, at 540. The GPS position information is based at least in part on the transmitted location information. For example, with reference to FIGS. 1-2, the mobile station 110 may provide the prefix information received from the base station 280 or PDE 140 to the GPS module 124. The GPS module 124 and GPS receiver 126 may use the prefix information to calculate or determine the GPS position of the mobile station 110 in an accelerated fashion.

The method 500 of FIG. 5 may thus enable earlier and/or faster GPS fix determination at a mobile station based on prefix information provided to the mobile station by a PDE. Upon determining the GPS fix, the mobile station may use the GPS fix to access location-based services. For example, the GPS fix may be provided to an emergency call operator during an E911 call. As another example, the GPS fix may be used by an application at the mobile station (e.g., a camera application, a communication application, or a social networking application).

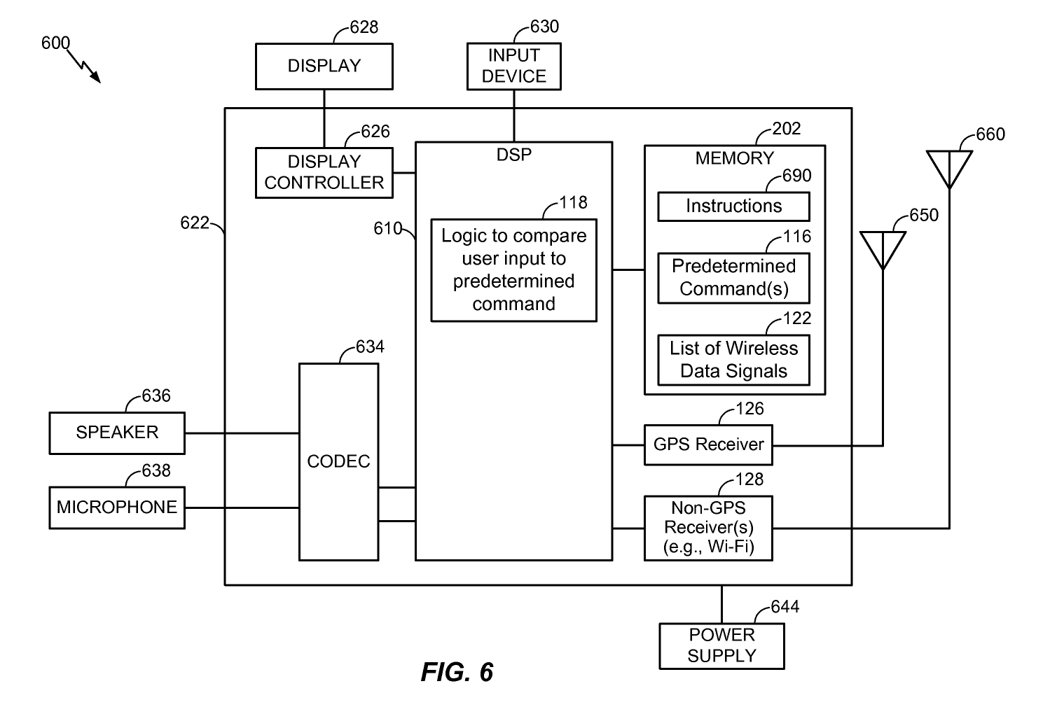

Referring to FIG. 6, a block diagram of a particular illustrative embodiment of a wireless device that includes a processor operable to perform location determination of the wireless device is depicted and generally designated 600. The device 600 includes a processor, such as a digital signal processor (DSP) 610, coupled to the memory 202. In a particular embodiment, the DSP 610 is the processor 120 of FIGS. 1-2. The memory 202 may store the list 122 of wireless data signals that are detectable by the device 600. For example, the list 122 of wireless data signals may be generated and transmitted to a base station (e.g., the base station 208 of FIG. 2) or a PDE (e.g., the PDE 140 of FIGS. 1-2) before a request for location information is received at the device 600.

The memory 202 may also store the plurality of predetermined commands 116. For example, the predetermined commands 116 may include a command to initiate a call to an emergency phone number (e.g., 911) or a command to launch an application at the device 600 (e.g., a camera application, a navigation application, a communication application, a social networking application, etc).

The memory 202 may also include instructions 690 that are executable by the DSP 610. For example, the instructions 690 may include instructions that, when executed by the DSP 610, cause the DSP 610 to perform various functions, logic operations, and methods described herein (e.g., including operations described with reference to the logic 118 of FIGS. 1-2 and the methods 400, 500 of FIGS. 4-5). For example, the DSP 610 may include or execute instructions corresponding to the logic 118 to compare user input to predetermined commands. A user input (e.g., the user input 114 of FIG. 1) may be received at an input device 630 coupled to the DSP 610 and the logic 118 within or implemented by the DSP 610 may compare the input to predetermined commands 116. In response to determining that the user input 114 corresponds to one of the predetermined commands 116, the DSP 610 may initiate a wireless data signal (i.e., non-GPS signals) scan to generate the list 122 of wireless data signals. The input device 630 may be a keypad, a touchscreen, or any other type of input device for receiving a user input at the device 600. A user input associated with determining a location of the device 600 may also be received from a microphone 638 (e.g., a voice command to “dial 911”). The predetermined command 116 may include a partial voice command, such as “dial 91” or “dial poli” for the police).

FIG. 6 also shows a display controller 626 that is coupled to the DSP 610 and to a display 628. A coder/decoder (CODEC) 634 (e.g., an audio and/or voice CODEC) can be coupled to the DSP 610. A speaker 636 and the microphone 638 can be coupled to the CODEC 634. FIG. 6 also indicates that the GPS receiver 126 is coupled to a first wireless antenna 650 and at least one non-GPS receiver 128 is coupled to a second wireless antenna 660. The GPS receiver 126 may be configured to receive GPS signals at the device 600. In addition, although the at least one non-GPS receiver 128 is illustrated as a Wi-Fi receiver, the at least one non-GPS receiver 128 may include wireless local area network (WLAN) signal and other wireless data signal detection capabilities. For example, the wireless data signals may be local wireless local area network (WLAN) signals such as defined by the IEEE specifications 802.11x or 802.15x, wireless wide area network (WWAN) signals, wireless personal area network (WPAN) signals, third generation partnership project (3GPP) signals, third generation partnership project 2 (3GPP2) signals, global system for mobile communications (GSM) signals, code division multiple access (CDMA) signals, time division multiple access (TDMA) signals, frequency division multiple access (FDMA) signals, orthogonal frequency division multiple access (OFDMA) signals, single-carrier frequency division multiple access (SC-FDMA) signals, long term evolution (LTE) signals, worldwide interoperability for microwave access (WiMAX) signals, television (TV) signals, quick response (QR) codes, near field communications (NFC) signals, digital advanced mobile phone system (D-AMPS) signals, or any combination thereof.

The first wireless antenna 650 and the second wireless antenna 660 may also be coupled to one or more transceivers (not shown). In a particular embodiment, the DSP 610, the display controller 626, the memory 202, the CODEC 634, the GPS receiver 126, and the non-GPS receiver(s) 128 are included in a system-in-package or system-on-chip device 622.

In a particular embodiment, the input device 630 and a power supply 644 are coupled to the system-on-chip device 622. Moreover, in a particular embodiment, as illustrated in FIG. 6, the display 628, the input device 630, the speaker 636, the microphone 638, the first wireless antenna 650, the second wireless antenna 660, and the power supply 644 are external to the system-on-chip device 622. However, each of the display 628, the input device 630, the speaker 636, the microphone 638, the first wireless antenna 650, the second wireless antenna 660, and the power supply 644 can be coupled to a component of the system-on-chip device 622, such as an interface or a controller.

It should be noted that although FIG. 6 depicts a wireless communications device, the DSP 610 and the memory 202 may also be integrated into other devices, such as a multimedia player, an entertainment unit, a navigation device, a personal digital assistant (PDA), a fixed location data unit, or a portable computer (e.g., a laptop computer or a tablet computer).

In conjunction with the described embodiments, an apparatus is disclosed that includes means for receiving a command corresponding to a user input at a mobile device. For example, the means for receiving a command may be the user interface 112 of FIGS. 1-2, the input device 630 of FIG. 6, the microphone 638 of FIG. 6, one or more other devices configured to receive a command corresponding to a user input, or any combination thereof.

The apparatus may also include means for comparing the received command to a predetermined command associated with determining a location of the mobile device. For example, the means for comparing may include the logic 118 of FIGS. 1-2 and 6, the processor 120 of FIGS. 1-2, the DSP 610 of FIG. 6, one or more other devices configured to compare received commands to predetermined commands, or any combination thereof.

The apparatus may further include means for initiating a wireless data signal scan to generate a list of wireless data signals that are detectable by the mobile device in response to determining that the received command corresponds to the predetermined command. For example, the means for initiating a wireless data signal scan may include the processor 120 of FIGS. 1-2, the non-GPS receiver(s) 128 of FIGS. 1, 2, and 6, the DSP 610 of FIG. 6, one or more other devices configured to initiate a wireless data signal scan, or any combination thereof.

Those of skill would appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in firmware, in a software module executed by a processor, or in a combination thereof. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), digital versatile disc (DVD) memory, floppy disk memory, Blu-ray disc memory, or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal. In alternate embodiments, programmable logic devices (PLDs), field programmable gate arrays (FPGAs), controllers, micro-controllers, and other electronic units may be used.

It should be noted that although the description herein largely refers to GPS position acquisition, other global, regional, and/or local systems, may also be used. Examples of such systems include, but are not limited to Galileo, GLONASS, NAVSTAR, Quasi-Zenith Satellite System (QZSS) over Japan, Indian Regional Navigational Satellite System (IRNSS) over India, Beidou system over China, and other earth-orbiting satellite vehicles or satellite based augmentation systems (SBASs). SBASs may include wide area augmentation system (WAAS), European geostationary navigation overlay service (EGNOS), multifunctional satellite augmentation system (MSAS), GPS aided geo augmented navigation or GPS and geo augmented navigation system (GAGAN), etc. Moreover, location determination may be implemented in conjunction with pseudolites and/or femtocells or a combination of systems that includes pseudolites and/or femtocells.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
receiving a command corresponding to user input at a user interface of a mobile device;
comparing, at the mobile device, the received command to a predetermined set of commands associated with determining a location of the mobile device; and
in response to determining that the received command corresponds to at least one command of the predetermined set of commands, initiating a wireless data signal scan at the mobile device to generate a list that identifies non-global positioning system (non-GPS) signals that are detectable by the mobile device.

2. The method of claim 1, wherein the wireless data signal scan is initiated before receiving a location request from a base station of a wireless network or from a position determining entity (PDE).

3. The method of claim 1, wherein the wireless data signal scan is initiated before initiating a global positioning system (GPS) session at the mobile device.

4. The method of claim 1, wherein the predetermined set of commands includes a command to initiate a call to an emergency phone number.

5. The method of claim 4, further comprising:
initiating the call to the emergency phone number; and
transmitting the list to enable position determination by a network position determining entity (PDE) after initiating the call,
wherein the wireless data signal scan is initiated prior to receiving a request for wireless network measurements during the call.

6. The method of claim 5, wherein the wireless data signal scan includes a scan of frequencies allocated to a wireless local area network (WLAN) that comply with an Institute of Electrical and Electronics Engineers (IEEE) 802.11 protocol, and wherein the list includes media access control (MAC) information of detected WLAN access points.

7. The method of claim 1, further comprising:
transmitting the list to a base station of a wireless network to enable position determination by a position determining entity (PDE) having access to a database of locations of wireless network access points;
receiving location information from the base station based on the position determination; and
providing the location information to a global positioning system (GPS) module of the mobile device,
wherein the location information is utilized at the GPS module to obtain GPS position information corresponding to the mobile device.

8. The method of claim 1, wherein the predetermined set of commands includes a command to launch an application at the mobile device, wherein the application is configured to request global positioning system (GPS) position information from a GPS module of the mobile device.

9. The method of claim 1, wherein the wireless data signals include at least one of wireless local area network (WLAN) signals, wireless wide area network (WWAN) signals, wireless personal area network (WPAN) signals, third generation partnership project (3GPP) signals, third generation partnership project 2 (3GPP2) signals, global system for mobile communications (GSM) signals, code division multiple access (CDMA) signals, time division multiple access (TDMA) signals, frequency division multiple access (FDMA) signals, orthogonal frequency division multiple access (OFDMA) signals, single-carrier frequency division multiple access (SC-FDMA) signals, long term evolution (LTE) signals, worldwide interoperability for microwave access (WiMAX) signals, television (TV) signals, quick response (QR) codes, near field communications (NFC) signals, or digital advanced mobile phone system (D-AMPS) signals.

10. An apparatus comprising:
a processor configured to:
receive a command corresponding to a user input at a user interface of a mobile device;
compare the received command to a predetermined command associated with determining a location of the mobile device; and
in response to determining that the received command corresponds to the predetermined command, initiate a wireless data signal scan to generate a list that identifies non-global positioning system (non-GPS) signals that are detectable by the mobile device.

11. The apparatus of claim 10, wherein the processor is further configured to initiate the wireless data signal scan before receiving a location request from a base station of a wireless network or from a position determining entity (PDE).

12. The apparatus of claim 10, wherein the processor is further configured to initiate the wireless data signal scan before initiating a global positioning system (GPS) session at the mobile device.

13. The apparatus of claim 10, wherein the predetermined command is related to initiating a call to an emergency phone number.

14. The apparatus of claim 13, wherein the processor is further configured to initiate the call to the emergency phone number.

15. A mobile device comprising:
a user interface configured to receive a user command;
a first receiver configured to receive global positioning system (GPS) signals;
a second receiver configured to receive non-GPS signals;
a memory storing a predetermined commands associated with determining a location of the mobile device; and
a processor coupled to the memory, wherein the processor is configured to:
compare the user command received via the user interface to the predetermined command; and
in response to the user command corresponding to at least part of the predetermined command, initiate a wireless data scan at the second receiver to generate a list of wireless data signals that are detectable by the second receiver.

16. The mobile device of claim 15, wherein the processor is further configured to initiate the wireless data signal scan before receiving a location request from a base station of a wireless network or from a position determining entity (PDE).

17. The mobile device of claim 16, further comprising a transmitter configured to transmit the list to the base station or to the PDE.

18. The mobile device of claim 15, wherein the processor is further configured to initiate the wireless data signal scan before initiating a GPS session at the first receiver, and wherein the wireless data signals do not include GPS signals.

19. The mobile device of claim 15, wherein the predetermined command comprises a plurality of predetermined commands including at least one command related to initiating a call to an emergency phone number.

20. The mobile device of claim 19, wherein the processor is further configured to initiate the call to the emergency phone number.

21. A non-transitory computer-readable medium comprising instructions that, when executed by a processor, cause the processor to:
receive a command corresponding to a user input at a user interface of a mobile device;
compare the received command to a predetermined command associated with determining a location of the mobile device; and
initiate a wireless data signal scan to generate a list of non-global positioning system (non-GPS) signals that are detectable by the mobile device in response to determining that the received command corresponds to the predetermined command.

22. The non-transitory computer-readable medium of claim 21, further comprising instructions that, when executed by the processor, cause the processor to initiate the wireless data signal scan before receiving a location request from a base station of a wireless network or from a position determining entity (PDE).

23. The non-transitory computer-readable medium of claim 21, further comprising instructions that, when executed by the processor, cause the processor to initiate the wireless data signal scan before initiating a global positioning system (GPS) session at the mobile device.

24. The non-transitory computer-readable medium of claim 21, wherein the predetermined command is a command to initiate a call to an emergency phone number.

25. The non-transitory computer-readable medium of claim 24, further comprising instructions that, when executed by the processor, cause the processor to:
initiate the call to the emergency phone number; and
transmit the list to enable position determination by a position determining entity (PDE) after initiating the call, wherein the wireless data signal scan is initiated prior to receiving a request for wireless data network measurements, and wherein the request for wireless data network measurements is received during the call.

26. The non-transitory computer-readable medium of claim 21, further comprising instructions that, when executed by the processor, cause the processor to:
transmit the list to a base station of a wireless network to enable position determination by a position determining entity (PDE) having access to a database of locations of wireless network access points;
receive location information from the base station based on the position determination by the PDE; and
provide the location information to a global positioning system (GPS) module of the mobile device,
wherein the location information is used by the GPS module to obtain GPS position information corresponding to the mobile device.

27. An apparatus comprising:
means for receiving a command corresponding to a user input at a mobile device;
means for comparing the received command to a predetermined command associated with determining a location of the mobile device; and
means for initiating a wireless data signal scan to generate a list of non-global positioning system (non-GPS) signals that are detectable by the mobile device in response to determining that the received command corresponds to the predetermined command.

28. The apparatus of claim 27, wherein the means for initiating further includes means for initiating the wireless data scan before receiving a location request from a base station of a wireless network or from a position determining entity (PDE).

29. The apparatus of claim 27, wherein the means for initiating further includes means for initiating the wireless data scan before initiating a global positioning system (GPS) session at the mobile device.

30. The apparatus of claim 29, wherein the predetermined command is a command to initiate a call to an emergency phone number.

31. A method comprising:
receiving, at a position determining entity (PDE), a list from a mobile device, wherein the list identifies non-global positioning system (non-GPS) signals that are detectable by the mobile device, and wherein the list is received by the PDE independent of transmitting a request for location information from the PDE to the mobile device;
determining location information associated with the mobile device based on the list;
transmitting the location information to the mobile device; and
receiving global positioning system (GPS) position information from the mobile device, where the GPS position information is based at least in part on the location information transmitted from the PDE to the mobile device.

32. The method of claim 31, wherein the list is received from the mobile device in response to entry of a command at the mobile device, the command associated with determining a location of the mobile device.

33. The method of claim 31, wherein the list of wireless data signals is associated with one or more wireless access points, and wherein determining the location information comprises accessing a database to identify the location information based on the one or more wireless access points.

34. The method of claim 31, wherein the PDE is included in a base station.
